(19) United States
(12) Patent Application Publication
(10) Pub. No.: US 2022/0344735 A1
(43) Pub. Date: Oct. 27, 2022

(54) SEPARATION METHOD OF BLACK POWDER OF AUTOMOTIVE WASTE SECONDARY BATTERY

(71) Applicant: Hyo Soo AHN, Seoul (KR)

(72) Inventor: Hyo Soo AHN, Seoul (KR)

(21) Appl. No.: 17/237,277

(22) Filed: Apr. 22, 2021

(51) Int. Cl. H01M 10/54; C22B 7/00

(52) U.S. Cl. CPC H01M 10/54; C22B 7/005

(57) ABSTRACT

Proposed is a separation method of black powder of an automotive waste secondary battery. More particularly, a method of separating a black powder (Ni, Co, Mn, Li C)+metal (Cu, Al) compound extracted from an automotive waste secondary battery through magnetic separation and particle separation is proposed. The separation method of black powder of an automotive waste secondary battery according to an embodiment of the present disclosure includes: (a) extracting black powder+metal compound from a waste secondary battery; (b) separating the black powder+metal compound into black powder and a metal compound through particle separation; and (c) separating Co and Ni, and non-extracted Mn, Li, and C by extracting Co and Ni from the black powder through gravity separation.

### BACKGROUND OF THE INVENTION

### Field of the Invention

The present disclosure relates to a separation method of black powder of an automotive waste secondary battery and, more particularly, to a method of separating a black powder (Ni, Co, Mn, Li C)+metal (Cu, Al) compound extracted from an automotive waste secondary battery through magnetic separation and particle separation.

### Description of the Related Art

UBS, which is an investment bank of Switzerland, expects that the ratio of electric vehicles, which is about 1% (about 1 million) of the annual car production (about 100 million) of the world in 2017, will increase up to 14% in 2025.

The current backlog of the manufacturers of the secondary battery for electric vehicles in Korea is estimated as about a total of 250 trillion won, and as the backlog increases, more products are necessarily manufactured and waste secondary products and poor products also unavoidably increase.

According to Act on promotion of development and distribution of environment-friendly motor vehicles (abbreviation: Low of environment-friendly motor vehicles), an environment-friendly vehicle refers to an electric vehicle, a plug-in hybrid vehicle, a hybrid vehicle, a fuel cell vehicle (hydrogen vehicle), and a solar electric vehicle, and waste secondary batteries usually come from these vehicles.

It is expected that automotive waste secondary batteries will rapidly increase to about 118 MWh in 2021, which is about eight times, from 15 MWh in 2018 due to increasing distribution of the energy storage system (ESS) of electric vehicles (EV).

Further, recently, as the interest in renewable energy such as green growth, solar energy, wind power increases, the demands for high-capacity secondary batteries for electric vehicles and energy storage systems are also rapidly increasing.

A lithium secondary battery that is most generally used as the automotive secondary battery is usually composed of a cathode having a cathode active material, an anode having an anode active material, a separator (membrane), and an electrolyte, accounts for about 50% of the entire manufacturing cost, and is charged and discharged by high lithium ion insertion-separation.

In the manufacturing cost of the material accounting for 50% of the manufacturing cost, the cathode accounts for the largest ratio, and the membrane, anode, and electrolyte sequentially account for the other ratios.

The cathode active material of automotive waste secondary battery includes transition metal such as nickel (Ni), lithium (Li), and cobalt (Co), and nickel (Ni), lithium (Li), and cobalt (Co) are expensive metals.

A large amount of poor products are generated in each of steps in the manufacturing process due to the characteristic of automotive waste secondary batteries that the performance and quality are important. The wasted poor products have a large amount of valuable metal such as cobalt (Co), nickel (Ni), lithium (Li), manganese (Mn), and graphite (C) and an electrode plate is made of copper (Cu) and aluminum (Al), so the poor products of automotive waste secondary batteries are wastes having a high recycling value.

In particular, considering that cobalt and nickel are not only rare metals, but used in various fields such that a war to keep the amount occurs all over the world, and Korea imports almost all of cobalt and nickel, smooth supply and demand of the materials through recycling can act as motive power of increasing the international competitiveness of domestic companies.

In the related art, a metal plate, cathode materials (Co, Ni, and Mn), and an anode material (graphite) are crushed together, using a mechanical sorting method that performs crushing and pulverizing through milling, and then the metal plate and the black powder (the mixture of the anode material and the cathode material) are separated on the basis of the grain sizes in order to recycle a waste secondary battery. However, since the metal plate and the black powder are strongly combined by a binder material, efficiency of separation is low and there is limitation in removal of a PE film that is a membrane.

Further, since Ni and Co that are ferromagnetic materials change into nonmagnetic material due to a change of the property when a secondary battery is manufactured, Ni and Co cannot be separated through magnetic separation, so gravity separation using a cyclone dust collector is used to collect the material in the related art. However, the efficiency of separation is very low, so they are recycled with graphite mixed therein (it takes a lot of costs and loss to remove graphite that is an impurity).

### DOCUMENTS OF RELATED ART

(Patent Document 1) Korean Patent No. 10-0358528 (published on Oct. 25, 2002).

### SUMMARY OF THE INVENTION

The present disclosure has been made in an effort to solve the problems described above and an objective of the present disclosure is to provide a separation method of black powder of an automotive waste secondary battery, the method being able to reduce a fuel cost by thermally decomposing, separating, and converting a PE film that is a membrane into fuel through low-temperature thermal decomposition in order to overcome the limitation in sorting and collecting of existing automotive waste secondary batteries, make sorting economical and efficient, and improve a collection ratio, and being able to improve the economic added value, reduce a sorting cost and a loss of black powder, and improve a collection ratio over 90% by recovering the magnetism of Ni and Co non-magnetized by thermal contact, powdering Ni and Co, extracting black powder and a metal compound, separating the black powder and the metal through a particle separation process, and collecting Ni and Co that are expensive from the black powder through gravity separation.

In order to achieve the objectives, a separation method of black powder of an automotive waste secondary battery according to an embodiment of the present disclosure includes: (a) extracting black powder+metal compound from a waste secondary battery; (b) separating the black powder+metal compound into black powder and a metal compound through particle separation; and (c) separating Co and Ni, and non-extracted Mn, Li, and C by extracting Co and Ni from the black powder through gravity separation.

In the step (a), the black powder+metal compound may be extracted by putting, heating, and cooling an automotive waste secondary battery in the low-temperature thermal decomposition equipment, in which a membrane (PE film) may be decomposed and Co and Ni are powdered while the magnetism thereof may be recovered.

In the step (b), black powder and a metal compound mixed with non-separated black powder may be separated by putting black powder+metal compound into a primary particle sorter, and the metal compound and the black powder may be separated by pulverizing and then putting the metal compound mixed with non-separated black powder into a secondary particle sorter.

The primary particle sorter may be a trommel sorter and the secondary particle sorter may be a three-stage vibration particle sorter.

In the step (c), magnetic separation may be performed two times through primary and secondary magnetic separation.

The method may further perform separating Cu and Al by putting the metal compound into a vibration gravity sorter.

According to the present disclosure, black powder and a metal compound are extracted by thermally decomposing an automotive waste secondary battery at low temperature, the black powder and the metal compound are separated through particle separation, and then Ni and Co that are expensive are recovered from the black powder through magnetic separation. Accordingly, it is possible to improve the economic added value, reduce sorting cost and a loss of black powder, and improve a collection ratio over 90%.

### BRIEF DESCRIPTION OF THE DRAWINGS

The above and other objectives, features and other advantages of the present disclosure will be more clearly understood from the following detailed description when taken in conjunction with the accompanying drawings, in which:

FIG. 1 is a schematic view of a recycling system that is used for separating black powder of the present disclosure;

FIG. 2 is a schematic flowchart showing a recycling method using the recycling system shown in FIG. 1; and

FIG. 3 is a flowchart showing a separation method of black powder according to an embodiment of the present disclosure.

### DETAILED DESCRIPTION OF THE INVENTION

Hereafter, the configuration and operation of embodiments of the present disclosure are described with reference to the accompanying drawings.

It should be noted that even though same components are shown in different figures, they are given the same reference numerals and characters. In the following description of the present disclosure, detailed descriptions of well-known functions or configurations relating to the disclosure will not be provided so as not to obscure the description of the disclosure with unnecessary details.

Further, unless explicitly described otherwise, “comprising” any components will be understood to imply the inclusion of other components rather than the exclusion of any other components.

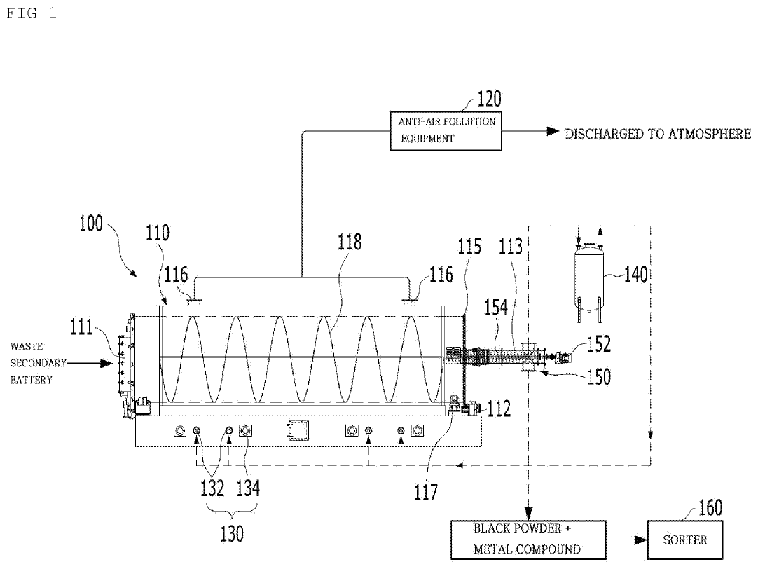

FIG. 1 is a schematic view of a recycling system that is used for separating black powder of the present disclosure.

As shown in FIG. 1, a recycling system 100 that is applied to the present disclosure substantially includes low-temperature thermal decomposition equipment 110, anti-air pollution equipment 120, a burner 130, a storage tank 140, and a conveyer 150.

The low-temperature thermal decomposition equipment 110 has a cylindrical shape for receiving a predetermined amount (e.g., 15 tons) of waste secondary batteries.

An inlet 111 through which waste secondary batteries are directly input without pre-processing such a crushing and pulverizing is formed on a side of the low-temperature thermal decomposition equipment 110, a discharge pipe 113 providing a passage for discharging a black powder+metal compound produced by thermal decomposition and cooling in the low-temperature thermal decomposition equipment 110 and a compound gas produced in the low-temperature thermal decomposition equipment 110 is horizontally installed on the other side, and several exhaust ports 116 for discharging exhaust gas purified through the anti-air pollution equipment 120 to the atmosphere are formed on the top.

The inside of the low-temperature thermal decomposition equipment 110 should be hermetically maintained to prevent a loss of heat during one-time thermal decomposition.

Accordingly, the low-temperature thermal decomposition equipment 110 may be designed to have large capacity (e.g., about 40 m³, a diameter of 2,700 mm, and a length of 7,000 mm) to be able to keep a large amount of waste secondary batteries at one time.

A screw-shaped cutter 118 is installed on the inner side of the low-temperature thermal decomposition equipment 110 to continuously move waste secondary batteries that are input therein.

The low-temperature thermal decomposition equipment 110 is rotatably supported by a support 117 composed of a bracket and a roller and has a gear 115 formed around a side. Further, a reduction geared motor 112 having a pinion making a pair with the gear 115 is installed at a side of the low-temperature thermal decomposition equipment 110, so the low-temperature thermal decomposition equipment 110 is rotated by the motor 112.

That is, the low-temperature thermal decomposition equipment 110 is a rotary kiln.

The low-temperature thermal decomposition equipment 110 may further have a blower (not shown) to increase the cooling efficiency when the low-temperature thermal decomposition equipment 110 is cooled at the room temperature after heated.

The burner 130 disposed under the low-temperature thermal decomposition equipment 110 and heating the low-temperature thermal decomposition equipment 110 may include several oil burner 134 and gas burners 132. The gas burners 132 can reuse a compound gas obtained by the system 100 and kept in the storage tank 140 as fuel.

The flame of the burner 130 is distributed and transmitted to the low-temperature thermal decomposition equipment 110 by a flame distributor, whereby the temperature of the low-temperature thermal decomposition equipment 110 is uniformly increased.

Exhaust gas heated by the burner 130 is sent to the anti-air pollution equipment 120 through the exhaust ports 116, purified, and then discharged to the atmosphere.

The anti-air pollution equipment 120 is composed of two steps of wet scrubber and activated carbon tower.

The wet scrubber collects and removes dust in fine particles contained in exhaust gas by spraying water (circulation water) and the activated carbon tower purifies exhaust gas before the exhaust gas is discharged to the atmosphere by absorbing and adsorbing various organic gases and offensive odors included in the exhaust gas.

The water (circulation water) circulates another cooling circulation water tank (not shown) and the pipeline system, whereby waste water is not produced.

The compound gas produced by heating in the anti-air pollution equipment 120 is naturally discharged to the storage tank 140 through the discharge pipe 113 on the side when the pressure of the anti-air pollution equipment 120 becomes slightly higher than the atmospheric pressure.

When a waste secondary battery directly put into the anti-air pollution equipment 120 without crushing and pulverizing, a binder material and an electrolyte membrane (PE film) included in the waste secondary battery are decomposed and removed. Further, Ni and Co changed into nonmagnetic materials when the secondary battery is manufactured are recovered into magnetic materials, whereby Ni and Co can be powdered.

A conveyer screw 154 of the conveyer 150 that conveys a black powder+metal compound is disposed in the discharge pipe 113 to be rotatable by the motor 152 that is a driving unit, so the black powder+metal compound is sent to a sorter 160.

The sorter 160 sorts and crushes the black powder+metal compound one or more times on the basis of the grain size, thereby separating the black powder+metal compound into black powder and a metal compound. Further, the sorter 160 separates the metal compound into Cu and Al through vibration gravity separation and separates, for example, cobalt (Co), Nickel (Ni), manganese (Mn), lithium (Li), graphite (carbon, C), etc. from the black powder through magnetic separation of one time or more.

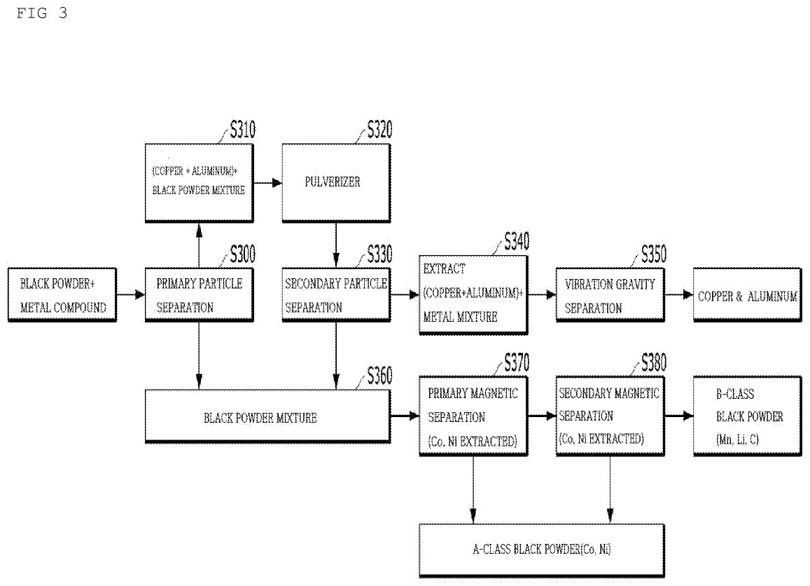

Sorting by the sorter 160 will be described below in detail with reference to FIG. 3.

The compound gas flowing into the discharge pipe 113 is stored in the storage tank 140 through the discharge pipe 113. Thereafter, the compound gas is input again as fuel of the gas burner 132 and then discharged to the atmosphere together with exhaust gas.

A set of three low-temperature thermal decomposition equipment 110 may be provided to be operated as a circulation system for inputting and heating at the first day, room-temperature cooling at the second day, and extracting at the third day.

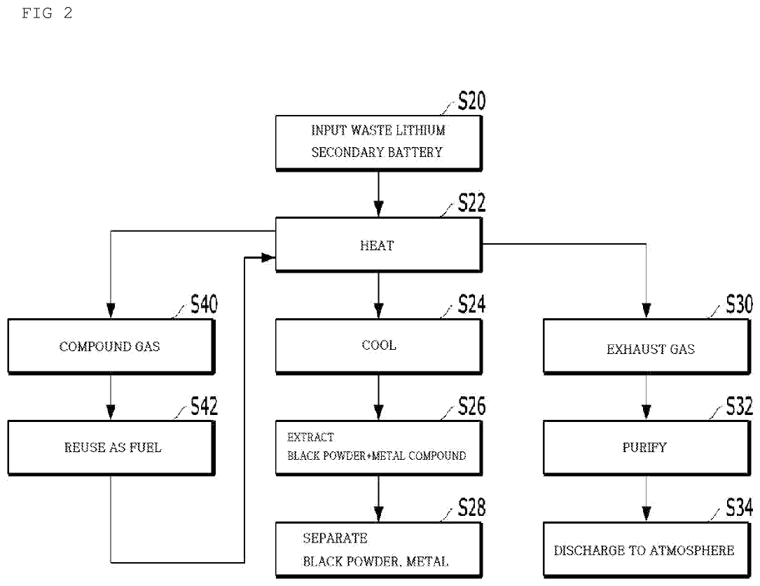

FIG. 2 is a schematic flowchart showing a recycling method using the recycling system shown in FIG. 1.

A poor product generated when a secondary battery is manufactured or a secondary battery that is dead after being used for an electric vehicle, etc., is prepared as a waste secondary battery.

A black powder+metal compound accounts for 94% of the waste secondary battery, and a binder material, an electrolyte membrane (PE film), moisture, etc. account for the other 6%.

Next, for example, at the first day, for example, 15 tons of the waste secondary batteries are directly put into the low-temperature thermal decomposition equipment 110 without pre-processing for crushing and pulverizing (S20) and then heated for 3˜5 hours by the burner 130, whereby a binder material and an electrolyte membrane (PE film) are decomposed and removed (S22).

In this case, the external temperature of the low-temperature thermal decomposition equipment 110 (the surface temperature of the steel plate of the low-temperature thermal decomposition equipment) may be 130˜170° C. the internal temperature at the inlet of the storage tank 140 depending on the external temperature may be 120˜160° C. and the internal temperature of the low-temperature thermal decomposition equipment 110 may be about 250° C.

When the external temperature is under 130° C. an electrolyte membrane (PE film) is not gasified and a binder material is not separated, and when it is over 170° C. agglomeration occurs due to the self-heat generation and separation is impossible.

The magnetism of Ni and Co can be recovered and Ni and Co can be powdered by such low-temperature thermal decomposition.

Next, for example, at the second day, the burner 130 is turned off and the low-temperature thermal decomposition equipment 110 is cooled at the room temperature for 12˜18 hours (S24).

In this case, the blower is operated and the rotary kiln, that is, the low-temperature thermal decomposition equipment 110 is rotated, thereby improving cooling efficiency.

At the third day, the black powder+metal compound is extracted by the discharge pipe 13 and the conveyer 150 (S26).

The extraction temperature is 70 Tor less.

Thereafter, the black powder+metal compound is separated into black powder and metal compound on the basis of the grain sizes through particle separation, and then the metal compound is separated again by vibration gravity separation and the black powder is separated again by gravity separation (S28).

Meanwhile, exhaust gas heated in the low-temperature thermal decomposition equipment 110 by the burner 130 (S30) is sent to the anti-air pollution equipment 120 through the exhaust ports 116 and purified (S32), and is then discharged to the atmosphere (S34).

That is, dust of the fine particles contained in the exhaust gas is collected and removed by water sprayed from the wet scrubber of the anti-air pollution equipment 120, and various organic gases and odors contained in the exhaust gas are absorbed and adsorbed by the activated carbon tower, whereby the exhaust gas is purified before being discharged to the atmosphere.

The compound gas produced by heating in the low-temperature thermal decomposition equipment 110 is stored in the storage tank 140 through the discharge pipe 113 (S40). Thereafter, the compound gas is put into the gas burner 132 again as fuel, burned, and then discharged to the atmosphere together with the exhaust gas (S42).

FIG. 3 is a flowchart showing a separation method of black powder according to an embodiment of the present disclosure.

First, as described above, a black powder+metal compound is extracted and obtained by putting, heating, and cooling a waste secondary battery in the low-temperature thermal decomposition equipment 110.

The black powder+metal compound accounts for 94% of the secondary battery.

Next, the black powder+metal compound is put into a primary particle sorter (e.g., trommel separator of Φ=700 and L=5,000) that is one of the components of the sorter 160 and sorted on the basis of the size (S300), whereby the black powder and the metal compound are separated (S360 and S310).

Large particles of the black powder are not sorted by primary particle separation in S300 and is separated with the metal compound in S310, so the metal compound+non-separated black powder is pulverized by a pulverizer that is one of the components of the sorter 160 (S320).

The pulverized metal compound+non-separated black powder is put into a secondary particle sorter (e.g., a three-stage vibration particle sorter) that is one of the components of the sorter 160 and is sorted on the basis of the size (S330), whereby a metal compound not containing the black powder is extracted (S340) and the black powder is separated again (S310).

Next, the metal compound accounting for 15% of the secondary battery is put into a vibration gravity sorter that is one of the components of the sorter 160 and sorted on the basis of the specific volume while vibration is applied (S350), whereby copper (Cu) and aluminum (Al) are separated.

Further, Co and Ni are extracted from the black powder through two-time, that is, primary and secondary gravity separation (S370 and S380), whereby Co and Ni that are A-class black powder are separated, and Mn, Li, and C that are non-extracted B-class black powder are separated.

That is, in S370 and S380, Co and Ni of the secondary battery recovered by low-thermal decomposition of the low-temperature thermal decomposition equipment 110 are sorted and extracted on the basis of magnetism using the ferromagnetic property thereof, but in this case, Mn and Li are nonmagnetic and C is diamagnetic, so Co and Ni are separated.

Co and Ni account for 45% of the secondary battery, and Mn, Li, and C account for 34% of the secondary battery.

Although the spirit of the present disclosure was described with reference to the accompanying drawings, this is only an example for describing the present disclosure without limiting the present disclosure.

Further, it is apparent that the present disclosure may be changed and copied in various ways without departing from the scope of the present disclosure.

What is claimed is:

1. A separation method of black powder of an automotive waste secondary battery, the method comprising:
(a) putting a waste secondary battery into low-temperature thermal decomposition equipment, uniformly increasing surface temperature of a steel plate of the low-temperature thermal decomposition equipment at 130˜170° C. through a plurality of burners installed under the low-temperature thermal decomposition equipment, decreasing the surface temperature, collecting a binder material and an electrolyte membrane included in the waste secondary battery through low-temperature thermal decomposition, reusing the compound gas as fuel of the burners, powdering Ni and Co while recovering magnetism of Ni and Co through low-temperature thermal decomposition, thereby extracting a black powder+metal compound from the waste secondary battery;
(b) separating the black powder+metal compound into black powder and a metal compound through particle separation; and
(c) separating Co and Ni, and non-extracted Mn, Li, and C by extracting Co and Ni from the black powder through gravity separation.

2. The method of claim 1, wherein, in the step (b), black powder and a metal compound mixed with non-separated black powder are separated by putting black powder+metal compound into a primary particle sorter, and the metal compound and the black powder are separated by pulverizing and then putting the metal compound mixed with non-separated black powder into a secondary particle sorter.

3. The method of claim 2, wherein the primary particle sorter is a trommel sorter and the secondary particle sorter is a three-stage vibration particle sorter.

4. The method of claim 1, wherein, in the step (c), magnetic separation is performed two times through primary and secondary magnetic separation.

5. The method of claim 1, further performing (d) separating Cu and Al by putting the metal compound into a vibration gravity sorter.
